(19) United States
(12) Patent Application Publication
(10) Pub. No.: US 2014/0305409 A1
(43) Pub. Date: Oct. 16, 2014

(54) Fuel System

(71) Applicant: Robert Bosch GmbH, Stuttgart (DE)

(72) Inventors: Stefan Arndt, Stuttgart (DE); Siamend Flo, Schwieberdingen (DE); Alexander Gluschke, Schwieberdingen (DE); Frank Nitsche, Remseck Am Neckar (DE); Thorsten Allgeier, Untergruppenbach (DE); Martin Maier, Moeglingen (DE); Roman Grzeszik, Dransfeld (DE); Henri Barbier, Bangalore (IN); Andreas Herzig, Leonberg (DE); Winfried Langer, Illingen (DE); Guenther Hohl, Stuttgart (DE); Juergen Arnold, Marbach Am Neckar (DE)

(21) Appl. No.: 14/364,615

(22) PCT Filed: Oct. 18, 2012
(86) PCT No.: PCT/EP2012/070628

§ 371 Date: Jun. 11, 2014

(30) Foreign Application Priority Data
Dec. 16, 2011 (DE) 102011088797.0

(51) Int. Cl. F02M 39/00

(52) U.S. Cl. CPC F02M 39/00
USPC 123/446

(57) ABSTRACT

A fuel system comprises a first reservoir for a first fuel in liquid phase that has a first vapor pressure, and a second reservoir for a second fuel in liquid phase that has a second vapor pressure. The second vapor pressure is higher than the first vapor pressure. The fuel system further includes a mixing device for mixing the first fuel in liquid phase with the second fuel in liquid phase, and an injector which is hydraulically connected to the mixing device and is configured so that as, or immediately after, the mixture passes through an outlet opening of the injector, the second fuel changes from the liquid phase to a gaseous phase.

### PRIOR ART

The invention relates to a fuel system according to the preamble of claim 1.

Fuel systems of internal combustion engines are commercially available which inject fuel into combustion chambers of the internal combustion engine by means of an injection system. Here, a fuel pressure, a fuel temperature, a fuel type and/or structural characteristics of the injection system influence the technical efficiency of the internal combustion engine and the chemical composition of the exhaust gas. Patent publications in this technical field include for example DE 44 44 417 A1 and DE 195 00 690 A1.

### DISCLOSURE OF THE INVENTION

The problem addressed by the invention is solved by means of a fuel system as claimed in claim 1. Subclaims specify advantageous refinements. Features that are important for the invention can also be found in the following description and in the drawings, wherein the features may be important for the invention both on their own and also in a wide variety of combinations, without this being explicitly mentioned again.

The invention has the advantage that, for a similar fuel pressure, a droplet size of a fuel mixture injected into a combustion chamber of an internal combustion engine can be reduced, whereby the combustion and the composition of the exhaust gas are improved. Correspondingly, for a similar droplet size, a fuel pressure of the fuel system can be lowered, whereby the fuel system as a whole can be simplified considerably. For example, the design of a high-pressure fuel pump and of fuel lines, sensors and/or injectors can be simplified considerably and thus made cheaper. Furthermore, both fuels used for the injection contribute to the combustion, such that the energy of the overall mixture is utilized for driving the internal combustion engine, and fuel consumption can be reduced. A particular cost advantage is obtained for fuel systems and internal combustion engines which are designed from the outset for (switchable) operation with multiple fuel types, for example gasoline and liquefied gas (LPG, “liquefied petroleum/propane gas”). The invention can be used both for a direct injection of fuel into a combustion chamber of the internal combustion engine and also for intake pipe injection. The invention is likewise applicable to Otto-cycle engines and to diesel engines.

The fuel system according to the invention has a first accumulator (fuel tank) for a first fuel, which is present in the liquid phase and which has a first vapor pressure, and a second accumulator for a second fuel, which is present in the liquid phase and which has a second vapor pressure. Here, the second vapor pressure is higher than the first vapor pressure. Furthermore, the fuel system has a mixing device for mixing the first fuel, which is present in the liquid phase, with the second fuel, which is present in the liquid phase. The mixing device is hydraulically connected to an injector (injection valve) arranged downstream, wherein the injector is designed such that, as or directly after the mixture passes through an outlet opening of the injector, the second fuel changes from the liquid phase into the gaseous phase. The two fuels are thus mixed with one another and injected jointly, and thus simultaneously, in the liquid state. Here, as far as the outlet opening, the fuel pressure is higher than the respective vapor pressure. A flow rate ratio of the first fuel with respect to the second fuel is for example ten to one.

Owing to the second fuel having a higher vapor pressure and/or lower boiling temperature than the first fuel, this has the effect that, during or directly after the injection, the second fuel changes abruptly into the gaseous state as a consequence of the pressure drop (“flash boiling”). Here, the volume of the second fuel likewise abruptly increases. Here, in the case of the first and second fuel having previously been thoroughly mixed, the surrounding first fuel is, as it were, “torn apart”, wherein a very great number of particularly small droplets of the first fuel is formed. Said small fuel droplets can evaporate particularly effectively. Here, a rate of evaporation is approximately inversely proportional to the square of the droplet diameter, resulting in correspondingly fast and optimized mixture formation in the combustion chamber.

Furthermore, the invention may also be used in the case of low-pressure intake pipe injection, in a diesel injection system or in injection systems for exhaust-gas aftertreatment (“AdBlue”)—for example in conjunction with carbon dioxide (CO2). The invention may likewise be used for a nozzle system of an oil-fired heater, for example for heating installations in buildings. In the case of internal combustion engines, the injection is in each case a relatively short process, whereas in the case of oil-fired heaters, the injection is more of a continuous process. The expression “fuel” should thus not be understood in a restrictive fashion, but rather encompasses all reacting fluids which are atomized and which undergo a pressure drop during the atomization, wherein the reason for the atomization is an enlargement of the reaction surface area and thus the highest possible degree of atomization with the smallest possible droplet diameters.

In particular, the invention provides that the first fuel is gasoline fuel or diesel fuel, and the second fuel is liquefied gas or methane or ethane. Liquefied gas, methane or ethane have a considerably higher vapor pressure than gasoline fuel or diesel fuel and are thus particularly suitable, with regard to the temperature and the pressure in the combustion chamber at the time of the injection, for distributing the gasoline fuel or the diesel fuel rapidly in the form of extremely fine droplets. In general, the vapor pressure refers to a—temperature-dependent and substance-dependent—ambient pressure below which a respective liquid begins to change into the gaseous phase.

A first embodiment of the fuel system provides that in each case one first and second fuel pump is arranged in a region of the first and second accumulator respectively, and that a pressure region of the first fuel pump and a pressure region of the second fuel pump are connected to the mixing device, and that the mixing device is connected, downstream, to a suction region of a common high-pressure fuel pump, and that a pressure region of the common high-pressure fuel pump is connected to a pressure accumulator from which the mixture can be fed to the injector. This arrangement requires a total of only one high-pressure fuel pump, and can thus be produced in a particularly simple and inexpensive manner.

It is additionally provided that the first and the second fuel pump and/or the common high-pressure fuel pump are electrically driven. An electric fuel pump can be controlled in a particularly simple and rapid manner with regard to a present fuel demand. In particular, it can be achieved that a required hydraulic minimum pressure (vapor pressure) is not undershot, such that gas bubbles are substantially prevented from forming upstream of the outlet opening of the injector.

A second embodiment of the fuel system provides that in each case one first and second fuel pump is arranged in a region of the first and second accumulator respectively, and that a pressure region of the first fuel pump is connected to a suction region of a first high-pressure fuel pump, and that a pressure region of the second fuel pump is connected to a suction region of a second high-pressure fuel pump, and that the pressure region of the first high-pressure fuel pump and the pressure region of the second high-pressure fuel pump are connected to the mixing device, and that the mixing device is connected, downstream, to a pressure accumulator from which the mixture can be fed to the injector. Here, the fuels are delivered by means of a respectively dedicated (predelivery) fuel pump and a downstream, respectively dedicated high-pressure fuel pump. In this way, the different properties of the two fuels can be allowed for in a particularly effective manner.

It is additionally provided that the first and/or the second fuel pump and/or the first and/or the second high-pressure fuel pump are electrically driven. The advantages of electric fuel pumps (for example an individual delivery rate which is independent of a present operating state of an internal combustion engine) can thus also be utilized for the second embodiment of the invention.

A third embodiment of the fuel system provides that the first and the second accumulator are designed as a common accumulator for the first and the second fuel, and that a fuel pump is arranged in a region of the common accumulator, and that a pressure region of the fuel pump is connected to a suction region of a high-pressure fuel pump, and that a pressure region of the high-pressure fuel pump is connected to a pressure accumulator from which the mixture can be fed to the injector. The “hydraulic” connection, so designated further above, between the mixing device and the injector thus comprises in the present case the common accumulator, an intermixing device (see further below) which is optionally arranged in the common accumulator and which serves for at least intermittently intermixing the first and the second fuel, the fuel pump, a low-pressure line from the fuel pump to the high-pressure fuel pump, a high-pressure line from the high-pressure fuel pump to the pressure accumulator, and a further high-pressure line from the pressure accumulator to the injector. Said arrangement can be implemented in a particularly simple and space-saving manner because the number of elements required for the fuel system according to the invention is reduced to a minimum. Here, the fuel pump may preferably be electrically driven and the high-pressure fuel pump may alternatively be electrically driven.

It is additionally provided that the common accumulator has an intermixing device that can mix the fuels. The intermixing of the fuels may take place before and/or during the operation of the internal combustion engine. It is achieved in this way that the fuels stored in the common accumulator are optimally mixed at all times.

In general, the invention additionally provides that a flow rate ratio of the first fuel and of the second fuel is adjustable. For example, the ratio of the first fuel with respect to the second fuel is—as already described above—ten to one. Any other desired ratio is however also possible, and said ratio may even be varied during the operation of the internal combustion engine. It is evident that even a relatively small fraction of the second fuel with respect to the first fuel is sufficient to permit optimum evaporation of both fuels in the combustion chamber. Thus, relatively little of the second fuel is required, whereby the fuel system according to the invention is particularly efficient.

It is furthermore provided that the mixing device comprises at least one proportional valve and/or a cyclically operating switching valve and/or a cyclically operating switchover valve and/or an aperture and/or a control slot arranged in a high-pressure fuel pump arranged downstream. In this way, various embodiments of the mixing device are made possible, which may thus be optimally coordinated with a respective fuel system. The—fast-switching—switchover valve makes it possible, for example, for the mixing ratio of the two fuels to be adjusted during a suction phase of the high-pressure fuel pump. The stated apertures are expedient in particular if the fuels are delivered in each case at an equal fuel pressure by means of in each case one predelivery pump. The—at least one—control slot may particularly expediently be used in the case of a stroke of a piston of the high-pressure fuel pump being invariable. In a fuel system corresponding to the described third embodiment, the mixing device may also comprise an intermixing device, for example an agitator or the like.

The fuel system according to the invention operates particularly reliably if the first and second fuel pump, respectively, and/or the first and second high-pressure fuel pump, respectively, can generate a respective fuel pressure that is higher than the respective vapor pressure of the delivered fuel. In this way, gas bubbles can be prevented from forming in the fuel system, and thus fault-free operation can be achieved.

Exemplary embodiments of the invention will be explained below with reference to the drawing, in which:

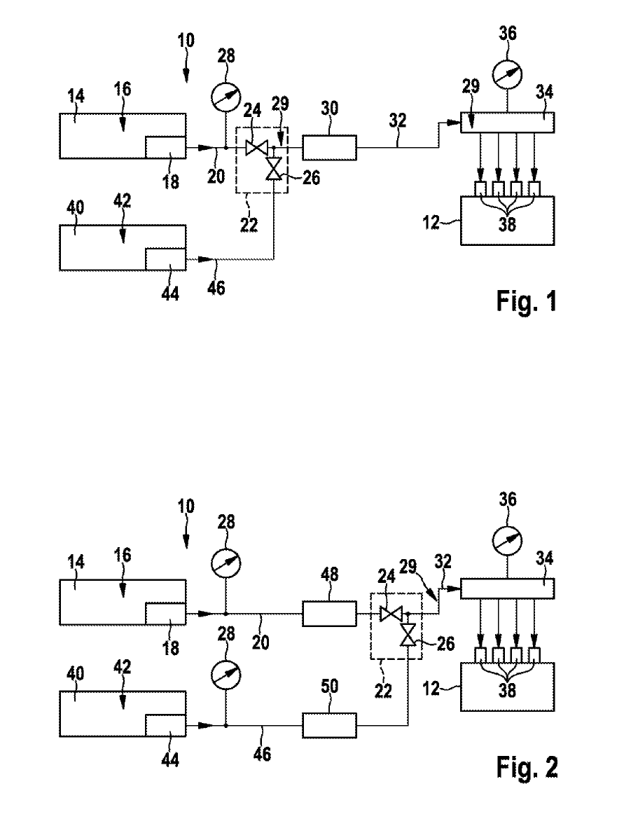

FIG. 1 shows a fuel system for an internal combustion engine in a first embodiment;

FIG. 2 shows the fuel system for the internal combustion engine in a second embodiment;

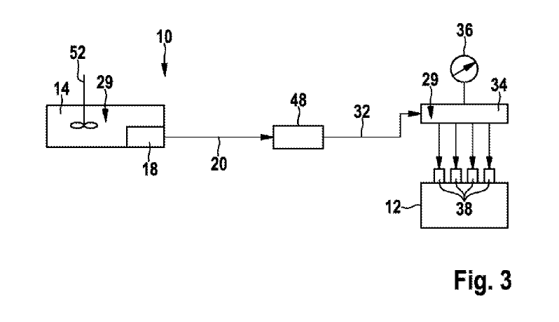

FIG. 3 shows the fuel system for the internal combustion engine in a third embodiment;

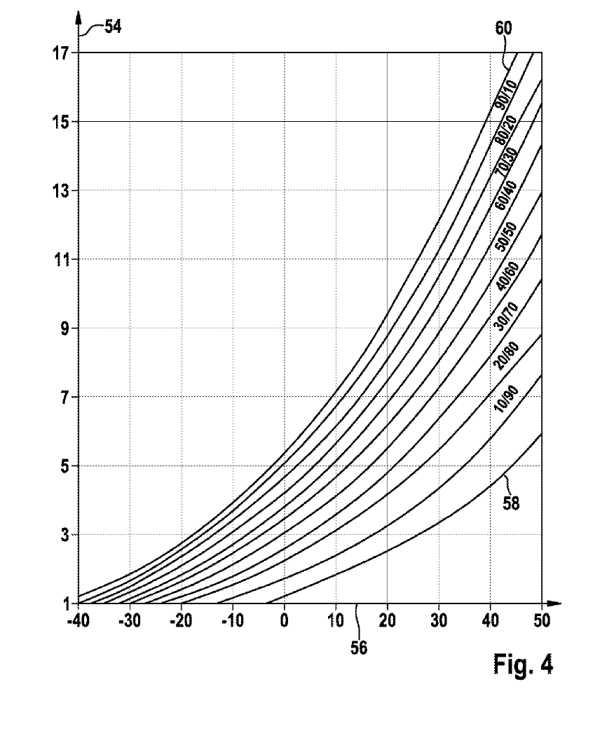

FIG. 4 shows a diagram of a vapor pressure versus a temperature;

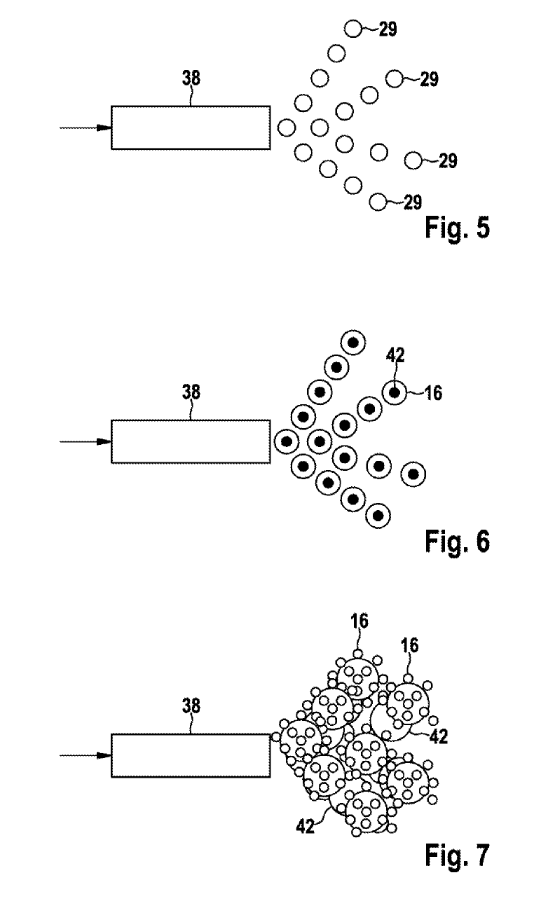

FIG. 5 is a schematic illustration of an injection process in a first state;

FIG. 6 is the schematic illustration of the injection process in a second state;

FIG. 7 is the schematic illustration of the injection process in a third state;

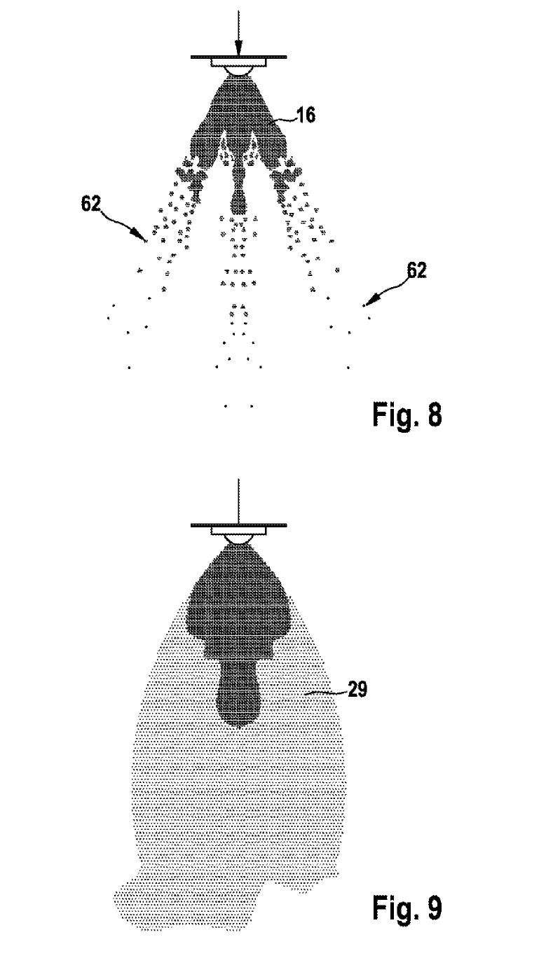

FIG. 8 shows an image of an injection process with a first fuel; and

FIG. 9 shows an image of an injection process with the first fuel and a second fuel.

In all of the figures, the same reference signs have been used for functionally equivalent elements and variables even in different embodiments.

FIG. 1 shows a first embodiment of a fuel system 10 for an internal combustion engine 12 in a simplified illustration. In an upper left-hand region in the drawing, there is illustrated a first accumulator 14 (fuel tank) for a first fuel 16, which in the present case is gasoline. On or in the first accumulator 14 there is arranged a first electrically driven fuel pump 18, which is connected at the outlet side, via a first low-pressure line 20, to a first inlet of a mixing device 22. The mixing device 22 comprises a first and a second proportional valve 24 and 26. On the first low-pressure line 20 there is arranged a first pressure sensor 28. Downstream, a mixture 29 formed in the mixing device 22 is fed to a suction region of an electrically driven high-pressure fuel pump 30.

At the outlet side, the electrically driven high-pressure fuel pump 30 is connected, via a high-pressure line 32, to a high-pressure fuel accumulator 34 (“rail”). On the high-pressure accumulator 34 there is arranged a second pressure sensor 36 by means of which a present fuel pressure in the high-pressure accumulator 34 can be determined. The high-pressure accumulator 34 is hydraulically connected, via fuel lines (without reference sign), to, in the present case, four injectors 38 (injection valves) of the internal combustion engine 12.

In the lower left-hand region in the drawing, there is illustrated a second accumulator 40 (fuel tank) for a second fuel 42, which in the present case is liquefied gas. On or in the second accumulator 40 there is arranged a second electrically driven fuel pump 44, which is connected at the outlet side, via a second low-pressure line 46, to a second inlet of the mixing device 22.

As an alternative to the proportional valves 24 and 26, the mixing device 22 may also comprise a cyclically operating switching valve, a fast-acting switchover valve or—in particular in the case of a first delivery pressure (“predelivery pressure”) of the fuel pumps 18 and 44 being equal—an aperture. The proportional valves 24 and 26 or the apertures determine the mixing ratio by means of a defined ratio of the product of opening cross section and first delivery pressure. For increased accuracy, it is possible for a hydraulic pressure damper to be arranged in each case upstream of the proportional valves 24 and or of the alternative apertures. Said fast-acting switchover valve can particularly expediently be used in the case of a high-pressure fuel pump 30 being designed with a piston, and makes it possible for the mixing ratio to be adjusted during the suction phase. The mixing device 22 may likewise comprise a control slot in the high-pressure fuel pump 30, which is particularly expedient if the high-pressure fuel pump 30 has a constant stroke.

During the operation of the internal combustion engine 12, the first electrically driven fuel pump 18 delivers gasoline from the first accumulator 14 via the first low-pressure line 20 into the mixing device 22, wherein a hydraulic pressure of the gasoline is increased to a first delivery pressure—for example up to 21 bar. The first delivery pressure is determined or monitored by means of the first pressure sensor 28. The proportional valve 24 of the mixing device 22 controls the gasoline flow rate fed to the electrically driven high-pressure fuel pump 30.

The second electrically driven fuel pump 44 delivers liquefied gas from the accumulator 40 via the second low-pressure line 46 likewise into the mixing device 22, wherein a hydraulic pressure of the liquefied gas is likewise increased to a first delivery pressure—for example up to 21 bar. The proportional valve 26 of the mixing device 22 controls the liquefied gas flow rate fed to the electrically driven high-pressure fuel pump 30. Here, the mixing device 22 is controlled by means of a control and/or regulating device (not illustrated in the drawing) of the internal combustion engine 12, which control and/or regulating device receives signals from various sensors, for example the pressure sensors 28 and 36.

The electrically driven high-pressure fuel pump 30 delivers the mixture 29 of gasoline and liquefied gas formed in the mixing device 22 at a second—higher—delivery pressure into the high-pressure line 32, and subsequently into the high-pressure accumulator 34. In the present case, the mixing device 22 is set such that a flow rate ratio of the first fuel 16 with respect to the second fuel 42 is ten to one, such that the internal combustion engine 12 is operated substantially with gasoline. From the high-pressure accumulator 34, the mixture 29 can be injected into a combustion chamber of the internal combustion engine 12 via a respective injector 38.

With the mixture 29 formed in the mixing device 22, the combustion can take place in the combustion chamber in a particularly effective manner, as will be explained in more detail below on the basis of FIGS. 5 to 9. Here, a ratio of the flow rates of gasoline with respect to liquefied gas may even be controlled during operation in accordance with a respective demand or operating state of the internal combustion engine 12. Together with a respectively adequately high first and second delivery pressure, it is achieved that a vapor pressure of the liquefied gas and of the gasoline is not undershot in the fuel system 10. Thus, the mixture 29 also remains in a liquid state on the path from the accumulators 14 and 40 to the point of injection by means of the injectors 38, wherein segregation is substantially prevented.

The liquefied gas may for example be butane or propane, or may have any desired ratio of butane with respect to propane, as long as a vapor pressure of the mixture is higher than the vapor pressure of the gasoline.

FIG. 2 shows a second embodiment of the fuel system for the internal combustion engine 12. Here, the first fuel pump 18 is connected via the first low-pressure line 20 to a suction region of a first high-pressure fuel pump 48, and the second fuel pump 44 is connected via the second low-pressure line 46 to a suction region of a second high-pressure fuel pump 50. The first and the second high-pressure fuel pump 48 and 50, respectively, may be electrically or mechanically driven. Any devices for controlling a delivery volume in the case of a mechanical drive of the high-pressure fuel pumps 48 and 50, such as for example a flow-rate control valve in the suction region of the high-pressure fuel pump 48 and/or 50, are not illustrated in the drawing.

At the outlet side, the high-pressure fuel pumps 48 and are connected in each case to the proportional valves 24 and 26 of the mixing device 22. Connected to an outlet of the mixing device 22 is the high-pressure line 32 which, as described with regard to FIG. 1, is connected to the high-pressure accumulator 34.

As an alternative to the proportional valves 24 and 26, it is possible—as already explained in more detail with regard to FIG. 1—for the mixing device 22 to also comprise a cyclically operating switching valve, a fast-acting switchover valve and/or an aperture. The mixing device 22 may likewise comprise a control slot in the high-pressure fuel pump 48 and/or 50.

During the operation of the internal combustion engine 12, the first electrically driven fuel pump 18 delivers gasoline from the first accumulator 14 to the high-pressure fuel pump 48 via the first low-pressure line 20 at a first delivery pressure of, for example, up to bar. The second electrically driven fuel pump 44 delivers liquefied gas from the second accumulator 40 to the high-pressure fuel pump 50 via the second low-pressure line 46 at a first delivery pressure of, for example, up to 21 bar. The high-pressure fuel pumps 48 and 50 increase the fuel pressure in each case to a second delivery pressure. The proportional valves 24 and 26 of the mixing device 22 control the ratio of the flow rates of gasoline and liquefied gas. The mixture 29 thus formed is subsequently fed to the high-pressure line 32.

FIG. 3 shows a third embodiment of the fuel system 10 for the internal combustion engine 12. Arranged in the left-hand region in the drawing is the accumulator 14, which in the present case is provided jointly for the first and second fuels 16 and 42 and which thus already contains the mixture 29 of gasoline and liquefied gas. The mixture 29 may preferably already be filled into the accumulator 14 in a ready-mixed state at a fueling station. Furthermore, the accumulator 14 has an intermixing device in the form of an agitator 52.

The first fuel pump 18 is connected to the suction region of the high-pressure fuel pump 48 via the first low-pressure line 20. Here, the high-pressure fuel pump 48 may be electrically or mechanically driven. At the outlet side, the high-pressure fuel pump 48 is, as already described above, connected to the high-pressure line 32.

During the operation of the fuel system 10, the mixture 29 is fed from the accumulator 14 to the suction region of the high-pressure fuel pump 48 via the low-pressure line 20. Here, the agitator 52, which is actuated at least intermittently, prevents segregation of the two fuels. The high-pressure fuel pump 48 delivers the mixture 29, as already described above, into the high-pressure line 32. As is likewise the case in the embodiments as per FIGS. 1 and 2, it is achieved, by means of an adequate first and second delivery pressure, that a vapor pressure of the mixture 29 is not undershot. The mixture 29 thus remains in a liquid state on the path from the accumulator 14 to the outlet openings of the injectors 38.

FIG. 4 shows a diagram of a vapor pressure 54 of the second fuel 42 versus a temperature 56. The temperature 56 of the second fuel 42 (liquefied gas) is plotted on the abscissa of the coordinate system illustrated. On the ordinate, the vapor pressure 54 of the liquefied gas is plotted, as a function of the temperature 56, in a respective composition. The drawing thus illustrates a set of curves which has the respective composition of the liquefied gas as a parameter. The unit of temperature 56 is “° C.” (degrees Celsius), and the unit of vapor pressure 54 is “bar”.

A lowermost curve 58 in the drawing corresponds to a butane gas which, in the present case, has 70 percent by weight of n-butane and 30 percent by weight of i-butane. An uppermost curve 60 in the drawing corresponds to a propane gas which, in the present case, has 96 percent by weight of pure propane, 2.5 percent by weight of ethane and 1.5 percent by weight of i-butane. The parameters with which the other curves are labeled indicate in each case a percentage fraction of butane gas and a percentage fraction of propane gas.

It can be seen that, with increasing temperature 56, the vapor pressure 54—that is to say the specific ambient pressure below which the liquefied gas changes into the gaseous phase—likewise rises. Furthermore, the respective vapor pressure 54 rises with increasing propane fraction. A high fraction of butane can thus, for otherwise unchanged conditions, reduce the risk of the formation of gas bubbles.

FIG. 5 is a schematic illustration of an injection process by means of the injector 38 in a first state. The injector 38 which is arranged in the left-hand region of the drawing sprays the mixture 29, toward the right in the drawing, into the combustion chamber (not illustrated in any more detail) of the internal combustion engine 12. In the state that is shown, first droplets of the mixture 29 have already been injected into the combustion chamber, wherein the mixture 29 is however still substantially in the liquid phase.

FIG. 6 shows the arrangement of FIG. 5 in a second state which follows the first state. The respective inner points or circles that are illustrated indicate the second fuel 42 (liquefied gas), and the respective larger, outer circles indicate the first fuel 16 (gasoline). In the illustrated state of evaporation, the liquefied gas, after emerging from the injector 38, begins to change very rapidly into the gaseous phase owing to the pressure drop that occurs as it emerges, wherein the volume likewise becomes very rapidly larger.

FIG. 7 shows the arrangement of FIG. 6 in a third state which follows the second state. In said third state, the liquefied gas has virtually completely changed into the gaseous phase. The intermixing—which is assumed to be good—of the gasoline and of the liquefied gas in the mixture 29 gives rise to the effect (the so-called “flash boiling effect”) that, in the process, the gasoline is atomized into a very large number of very small individual droplets. The evaporation of the gasoline can subsequently take place correspondingly rapidly, said gasoline making up in the present case approximately 90% of the mixture 29. This gives rise to a particularly rapid and effective combustion of the mixture 29 or of the gasoline in the combustion chamber. The liquefied gas likewise burns and thus contributes to the generation of torque in the internal combustion engine 12.

FIG. 8 shows a (diagrammatic) image of an injection performed only using the first fuel 16, that is to say using gasoline. In the drawing, the injection is taking place substantially from top to bottom, wherein the injector 38 is not illustrated. The image shown was captured in the case of an injection pressure of approximately 10 bar and an injection duration of approximately 2 ms (milliseconds). It is possible to clearly see relatively large individual droplets 62 of the gasoline.

FIG. 9 shows an injection similar to FIG. 8, which injection is however performed using the mixture 29, that is to say using approximately 90% gasoline and approximately 10% liquefied gas. The image shown was likewise captured in the case of an injection pressure of approximately 10 bar and an injection duration of approximately 2 ms.

It can be clearly seen how the injection of FIG. 9, by contrast to FIG. 8, forms a large-volume spray mist, wherein individual droplets are not visible or are scarcely visible at the present scale of the drawing. The fine structure visible in FIG. 9 arises substantially from a raster of the image or of the drawing.

1. A fuel system, comprising:
a first accumulator configured to receive a liquid phase first fuel having a first vapor pressure,
a second accumulator configured to receive a liquid phase second fuel having a second vapor pressure,
wherein the second vapor pressure is higher than the first vapor pressure;
a mixing device configured to mix the first fuel with the second fuel to form a fuel mixture; and
an injector that is hydraulically connected to the mixing device, that includes an outlet opening, and that is configured such that the second fuel of the fuel mixture changes from the liquid phase into a gaseous phase as, or directly after, the fuel mixture passes through the outlet opening of the injector.

2. The fuel system as claimed in claim 1, wherein:
the first fuel is gasoline fuel or diesel fuel; and
the second fuel is liquefied gas.

3. The fuel system as claimed in claim 1, further comprising:
a first fuel pump that is positioned in a region of the first accumulator and that includes a pressure region that is connected to the mixing device;
a second fuel pump that is positioned in a region of the second accumulator and that includes a pressure region that is connected to the mixing device;
a common high-pressure fuel pump that includes a suction region and a pressure region; and
a pressure accumulator configured to feed the fuel mixture to the injector,
wherein the mixing device is connected, downstream, to the suction region of the common high-pressure fuel pump, and
wherein the pressure region of the common high-pressure fuel pump is connected to the pressure accumulator.

4. The fuel system as claimed in claim 3, wherein at least one of:
the first fuel pump and the second fuel pump are electrically driven; and
the common high-pressure fuel pump is electrically driven.

5. The fuel system as claimed in claim 1, further comprising:
a first fuel pump that is positioned in a region of the first accumulator and that includes a pressure region;
a second fuel pump that is positioned in a region of the second accumulator and that includes a pressure region;
a first high-pressure fuel pump that includes a suction region that is connected to the pressure region of the first fuel pump and a pressure region that is connected to the mixing device:
a second high-pressure fuel pump that includes a suction region that is connected to the pressure region of the second fuel pump and a pressure region that is connected to the mixing device; and
a pressure accumulator configured to feed the fuel mixture to the injector,
wherein the mixing device is connected, downstream, to the pressure accumulator.

6. The fuel system as claimed in claim 5, wherein at least one of the following is electrically driven:
(i) the first fuel pump;
(ii) the second fuel pump;
(iii) the first high-pressure fuel pump; and
(iv) the second high-pressure fuel pump.

7. The fuel system as claimed in claim 1, further comprising:
a fuel pump that includes a pressure region;
a high-pressure fuel pump that includes a suction region that is connected to the pressure region of the fuel pump; and
a pressure accumulator that is configured to feed the fuel mixture to the injector and that is connected to a pressure region of the high-pressure fuel pump,
wherein the first accumulator and the second accumulator are a common accumulator for the first fuel and the second fuel,
wherein the fuel pump is positioned in a region of the common accumulator.

8. The fuel system as claimed in claim 7, wherein the common accumulator includes an intermixing device configured to mix the first fuel with the second fuel.

9. The fuel system as claimed in claim 1, wherein a flow rate ratio of the first fuel with respect to the second fuel is adjustable.

10. The fuel system as claimed in claim 1, wherein the mixing device includes at least one of:
at least one proportional valve;
a cyclically operating switching valve;
a cyclically operating switchover valve;
an aperture; and
a control slot located in a high-pressure fuel pump positioned downstream of the mixing device.

11. (canceled)

12. The fuel system as claimed in claim 3, wherein:
the first fuel pump is configured to generate a first fuel pressure;
the second fuel pump is configured to generate a second fuel pressure; and
the first fuel pressure and the second fuel pressure are each higher than a vapor pressure of the fuel mixture.

13. The fuel system as claimed in claim 3, wherein:
the common high-pressure pump is configured to generate a fuel pressure that is higher than a vapor pressure of the fuel mixture.

14. The fuel system as claimed in claim 5, wherein:
the first fuel pump is configured to generate a first fuel pressure;
the second fuel pump is configured to generate a second fuel pressure; and
the first fuel pressure and the second fuel pressure are each higher than a vapor pressure of the fuel mixture.

15. The fuel system as claimed in claim 5, wherein:
the first high-pressure fuel pump is configured to generate a first fuel pressure;
the second high-pressure fuel pump is configured to generate a second fuel pressure; and
the first fuel pressure and the second fuel pressure are each higher than a vapor pressure of the fuel mixture.
